(19) United States
(12) Patent Application Publication
(10) Pub. No.: US 2026/0274683 A1
(43) Pub. Date: Sep. 17, 2026

(54) METHOD OF FORMING N-DOPED CARBON NANOFOAM

(71) Applicant: PROMETHEON TECHNOLOGIES BV, Zele (BE)

(72) Inventor: Zacariah Austin HEIM, Zele (BE)

(21) Appl. No.: 19/479,997

(22) PCT Filed: Jun. 28, 2024
(86) PCT No.: PCT/EP2024/068357

§ 371 Date: Oct. 29, 2025

(30) Foreign Application Priority Data
Jun. 30, 2023 (GB) 2310027.4

(51) Int. Cl. C01B 32/354; C01B 32/15; C01B 32/318; H01M 4/90

(52) U.S. Cl. CPC C01B 32/382; C01B 32/15; C01B 32/318; H01M 4/9083

(57) ABSTRACT

The present disclosure relates to methods of forming an N-doped carbon nanofoam, which finds particular use as a fuel storage material. The N-doped carbon nanofoam is produced by introducing nitrogen to a carbon nanofoam, said nitrogen being introduced during or after formation of the carbon nanofoam. Many sources of nitrogen are useful including non-aqueous nitrogen sources. The method of the disclosure allows for large scale production of N-doped carbon nanofoams.

### CROSS-REFERENCE TO RELATED APPLICATIONS

This application is a National Stage Application of PCT/EP2024/068357, filed on Jun. 28, 2024, which claims priority to United Kingdom Patent Application No. 2310027.4, filed Jun. 30, 2023, and which applications are incorporated herein by reference. To the extent appropriate, a claim of priority is made to each of the above disclosed applications.

### FIELD

The present disclosure relates to a method of forming an N-doped carbon nanofoam. The N-doped carbon nanofoam of the disclosure is suitable for use as a conductive support scaffold for catalysts in fuel cells.

### BACKGROUND

Carbon materials provide useful electrocatalysts due to their high surface area, high conductivity and cost. Various types of carbon materials suitable for use as electrocatalysts are disclosed in X. Wang et al., Adv. Energy Mater., 2017, 7, 1700544.

Non-metal atoms such as N, P, S and B can be doped into the carbon structure, resulting in multiple possible configurations of doped carbon material. Being more electronegative than carbon, these heteroatoms make neighbouring carbon atoms electron deficient, thereby promoting oxygen adsorption on the carbon nanostructure. Doped carbon structures may take various forms, including nanotubes, sheets or particulate carbon materials.

Of these doping atoms, N is advantageous as it provides a stable material having the desired balance of properties. Specifically, the N-doping provides faster electron transfer, decreased bulk resistance and increased coupling efficiency when the material is modified by a catalytic metal. In contrast, doping with S and P typically acidifies the carbon leading to a material with higher pH sensitivity. Modification with S typically leaves a carbon material having a highly reactive surface, which can lead to poorer lifetime and side reactions occurring.

The present disclosure provides methods of making an N-doped carbon nanofoam material having excellent properties as a component in redox catalysts in fuel cells.

A known method of forming an N-doped carbon nanofoam is to heat a combined mixture of mesoporous carbon source and an aqueous acidic nitrogen source. Aqueous acidic nitrogen sources, for example nitric acid or nitrous acid are relatively cheap and provide efficient N-doping.

A drawback of using an aqueous acidic nitrogen source is that to provide high levels of N-doping, relatively high concentrations of the acid is required. In addition to N-doping, the harsh conditions can also cause pitting of the carbon nanofoam. Over-pitting or uncontrolled pitting results in loss of some of the mesoporous structure, which may decrease the surface area of the carbon nanofoam.

In addition, an aqueous acidic nitrogen source also promotes the formation of carboxylate groups surface of the material during N-doping. When carboxylate groups are formed, the conductivity of the resultant doped nanofoam is reduced leading to an inferior material for use in electronic systems e.g., fuel cells.

When using an aqueous acidic nitrogen source, the conditions therefore need to be carefully controlled in order to provide the desired amount of doping whilst simultaneously avoiding material degradation.

In addition, methods comprising an aqueous acidic nitrogen source pose serious health and safety risks when implemented on a large scale. This is not only impractical, but also expensive to manage and maintain when implemented on an industrial scale.

Accordingly, there is a need for a safe method of producing N-doped carbon nanofoams that provide the desired level of N-doping, without uncontrolled degradation the carbon nanofoam superstructure.

The method of the disclosure solves this problem by providing a method of forming an N-doped carbon nanofoam wherein the nitrogen source is a non-aqueous nitrogen source.

### SUMMARY

The present disclosure relates to the method of forming an N-doped carbon nanofoam, which nanofoam finds particular use as a fuel storage material. Further, the disclosure relates to an N-doped carbon nanofoam formed by said method.

According to a first aspect of the present disclosure is provided a method of forming an N-doped carbon nanofoam comprising the steps of:
i. providing a mixture of sugar, water, and hydrocarbon mediator;
ii. heating said mixture in the presence of a nitrogen source at 400° C. to 800° C. to form an N-doped carbon nanofoam;
iii. optionally, pitting the N-doped carbon nanofoam.

According to the present disclosure, there is provided a method of forming an N-doped carbon nanofoam comprising the steps of:
i. providing a mixture of sugar, water, and hydrocarbon mediator;
iia. heating said mixture at 100° C. to 600° C. to form a carbon nanofoam at least partially;
iib. heating said at least partially formed carbon nanofoam in the presence of a nitrogen source at 400° C. to 800° C. to form an N-doped carbon nanofoam;
iii. optionally, pitting the N-doped carbon nanofoam.

According to the present disclosure, there is provided a method of forming an N-doped carbon nanofoam comprising the steps of:
i. providing a mixture of sugar, water, hydrocarbon mediator and a nitrogen source;
ii. heating said mixture at 400° C. to 800° C. to form an N-doped carbon nanofoam;
iii. optionally, pitting the N-doped carbon nanofoam.

It should be understood that other embodiments, beyond the particular embodiments described, are possible as well. All modifications, equivalents, and alternative embodiments falling within the spirit and scope of the appended claims are covered as well.

The above discussion is not intended to represent every example embodiment or every implementation within the scope of the current or future claim sets. The figures and Detailed Description that follow also exemplify various example embodiments. Various example embodiments may be more completely understood in consideration of the following Detailed Description in connection with the accompanying Drawings.

### DETAILED DESCRIPTION

The disclosure provides a method of forming an N-doped carbon nanofoam and an N-doped carbon nanofoam formed by said method. The N-doped carbon nanofoam may be produced by introducing nitrogen to a carbon nanofoam, said nitrogen being introduced either during formation of the nanofoam, or after formation of the nanofoam.

The terms “N-doped carbon nanofoam”, “nitrogen doped carbon nanofoam”, “C_{nf}—Nₓ”, and “carbon nanofoam” may be used interchangeably throughout the disclosure.

Various N-sources may work including a non-aqueous nitrogen source.

Example embodiments of methods of forming an N-doped carbon nanofoam will be described.

Methods for making carbon nanofoams are known in the art, for instance in Sattler et al., Carbon 95 (2015), pp 434-441.

An example method of forming a carbon nanofoam material comprises:
a. providing a mixture of sugar, water and hydrocarbon mediator;
b. heating said mixture to form a carbon nanofoam.

To form an N-doped carbon nanofoam, nitrogen from a nitrogen source is introduced. The introduction of nitrogen occurs upon inclusion of a nitrogen source in step b.

By introducing nitrogen into the nanofoam, a mixture of pyridinic-N, pyrrolic-N and graphitic-N sites will be formed.

The resultant nanofoam may optionally be comminuted, for instance by milling. Milling may be carried out in a ball mill.

All the components used to form an N-doped carbon nanofoam are described below:

### Sugars

Suitable sugars to use include monosaccharides, disaccharides and trisaccharides, for instance sucrose, glucose or fructose, with sucrose being preferred.

The mixture of sugar and water is highly concentrated, namely at least 3 molar, typically at least 4 molar such as about 5 molar. Such high concentrations will typically require heating and vigorous stirring to fully dissolve the sugar, typically from 50° C. to 85° C., for instance from 60° C. to 80° C.

Typically, the concentrated sugar solution is cooled before the hydrocarbon mediator is added, for instance cooled to below 50° C.

### Hydrocarbon Mediator

Suitable hydrocarbon mediators include aromatic hydrocarbons such as pyrene, chrysene, benz[a]anthracene, fluoranthene, anthracene, naphthalene, benzene and hexane, with anthracene, naphthalene and benzene being preferred and naphthalene being most preferred.

Typically, only a small amount of hydrocarbon mediator (e.g., naphthalene) is required. For instance, the weight ratio of hydrocarbon mediator (e.g., naphthalene) to sugar (e.g., sucrose) is typically from 1:25,000 to 1:75,000, or 1:50,000 to 1:65,000.

### Nitrogen Source

To form an N-doped carbon nanofoam, a nitrogen source may be included in step i.

In the context of the disclosure, a “nitrogen source” is a molecule containing nitrogen. Preferably, the nitrogen source is at least 20% or more nitrogen by weight, for instance 30% or more, 40% or more, 50% or more, or 60% or more nitrogen by molecular weight.

For example, the nitrogen source may be selected from the group consisting of ammonia; urea; melamine; proteins such as albumin or egg whites; polymers such as polyacrylonitrile, polyvinylpyridine; heteroaromatic compounds such as triazine, pyrimidine, pyridazine, pyrazine, pyridine, pyrrole, imidazole, pyrazole, and 1,2,4-triazole; coal tar pitch; and/or mixtures thereof.

In some embodiments, the molecular nitrogen source is a small molecule containing nitrogen wherein “small molecule” is a molecule with a molecular weight of 200 g/mol or less. Examples of small molecule nitrogen sources are melamine, urea, ammonia, heteroaromatic compounds such as triazine, pyrimidine, pyridazine, pyrazine, pyridine, pyrrole, imidazole, pyrazole, and 1,2,4-triazole; and/or mixtures thereof.

In some embodiments, the molecular nitrogen source is a “large molecule” with a molecular weight above 200 g/mol. Examples of large molecule nitrogen sources are proteins, for example egg whites, albumin and/or mixtures thereof.

In some embodiments, the nitrogen source is a non-aqueous polymeric nitrogen source such as polyacrylonitrile, polyvinylpyridine and/or mixtures thereof.

In some embodiments, the nitrogen source is an aromatic organic molecule such as melamine, polyvinylpyridine, and/or mixtures thereof.

Nitrogen sources may belong to one, two or more of the above categories. For example, melamine is a small molecule nitrogen source that is also an aromatic organic molecule.

In order to provide homogenous N-doping, the nitrogen source should be broken down either before, or during step i. Breakdown may be facilitated thermally or mechanically.

In some embodiments, the nitrogen source is decomposed thermally. Preferably, thermal decomposition of the nitrogen sources occurs at least partially during step i to produce moieties capable of N-doping the carbon nanofoam. Accordingly, if using a thermally decomposing nitrogen source, it is preferable to select one that decomposes at a temperature below the temperature used in step i.

Examples of suitable nitrogen sources that decompose thermally to provide moieties capable of N-doping the carbon nanofoam are urea, proteins (e.g. albumin), egg whites, melamine, polyacrylonitrile, polyvinylpyridine, coal tar pitch, triazine, pyrimidine, pyridazine, pyrazine, pyridine, pyrrole, imidazole, pyrazole, 1,2,4-triazole, and/or mixtures thereof.

In a preferred embodiment, the nitrogen source is decomposed mechanically to provide moieties capable of N-doping the carbon nanofoam. Mechanical breakdown can be performed via ball milling of the carbon source (sugar) and the nitrogen precursor prior to step i. Preferably, the ball milling mechanical breakdown is solventless.

Examples of suitable nitrogen sources for mechanical breakdown are melamine, urea and/or mixtures thereof, which can be broken down by ball milling.

Nitrogen sources according to the disclosure may belong to one, two or more of the above decomposition categories.

For instance, in some embodiments the nitrogen source may be a small molecular nitrogen source that decomposes thermally, and in other embodiments the nitrogen source may be a polymeric nitrogen source that decomposes mechanically.

In other embodiments, the nitrogen source may undergo both mechanical and thermal decomposition. For instance, melamine and urea may be broken down partly by ball milling prior to step i and then broken down further by thermal treatment during step i.

In some embodiments, the nitrogen source comprises a combination of nitrogen sources from different categories. For instance, the nitrogen source may comprise both a molecular and a polymer non-aqueous nitrogen source that degrade thermally.

The nitrogen source should be provided in an amount sufficient to provide the desired level of N-doping. A suitable ratio of nitrogen source to sugar in step i can be selected to ensure the desired level of nitrogen in the final material.

In some instances, it may be beneficial to pre-treat the nitrogen source before mixing it with the sugar, water and hydrocarbon mediator.

As an example, when melamine is used, pre-treatment with formaldehyde and phytic acid may be carried out.

As a further example, pre-treatment by heating may be carried out.

### Templating Material

When a large molecule, such as a polymer, is used as a nitrogen source, it may be beneficial to provide a nano particle template to ensure homogeneous N-doping. Suitable template materials include nanoparticles such as ZnO, wherein preferably the nanoparticles have a diameter of between 30 and 40 nm.

When a templating material is used, it is beneficial to mix the nitrogen source and the templating material in a weight ratio of 10:1, for instance 8:1, 6:1, 4:1, 3:1, 2:1, 1.5:1 or 1:1. Preferably the nitrogen source and the templating material is mixed in a weight ratio of 2:1.

Before adding the sugar, water and hydrocarbon mediator, it is necessary to remove the templating material. Any suitable method for the chosen templating material may be used. For example, when ZnO nanoparticles are used as a templating material, the mixture may be cleaned with excess 1M HCl and water to remove the nanoparticles.

### Pitting Agent

Preferably, pitting is carried out after the N-doped carbon nanofoam has been formed.

The method of the disclosure may include a pitting agent in step iii. The pitting agent causes indentations to form in the surface of the final carbon nanofoam, further increasing the surface area.

In an embodiment of the disclosure, the N-doped carbon nanofoam undergoes pitting.

In the context of the disclosure, a “pitting agent” refers to a substance that causes activation of the composite material by e.g., increasing the surface area.

In comparison to aqueous, acidic nitrogen sources, the non-aqueous nitrogen sources according to this disclosure do not typically cause pitting. Accordingly, it may be beneficial to use a small, controlled amount of a pitting agent to ensure that the carbon nanofoam surface area is high.

By providing separate pitting agent and an N-doping agent, independent control over the degree of N-doping and the degree of pitting can be achieved.

Preferably, the pitting agent is an alkali or alkaline earth carbonate. When an alkali or alkaline earth carbonate pitting agent is used, regular, consistent pitting is achieved. Typically, alkali or alkaline earth carbonate pitting agents increase the number of mesopores within the material, wherein the mesopores have smooth or rounded edges. Rounded mesopores are particularly advantageous for hydrogen storage via physisorption.

Suitable pitting agents are those selected from K₂CO₃, NaOH, KOH or combinations thereof.

Preferably, the pitting agent is K₂CO₃.

The pitting agent should be included in an amount sufficient to increase and activate the surface, which typically required the pitting agent to be in (weight) excess. For example, the weight ratio of sugar to pitting agent may be 1:1.5 or more, for instance, 1:2 to 1:10, 1:2.5 to 1:8, or 1:3 to 1:5. Preferably the weight ratio of composite material:pitting agent is 1:3.

When a pitting agent is used, the surface area of the resultant material may be from 25% to 50% higher than for the same material before pitting. The amount by which the surface area is increased will depend on the volume/concentration of pitting agent, the temperature at which pitting is carried out, the length of the pitting step, and the type of pitting agent used.

### Method of Forming an N-Doped Carbon Nanofoam

An example method of forming an N-doped carbon nanofoam material comprises:
i. providing a mixture of sugar, water, and hydrocarbon mediator;
ii. heating said mixture in the presence of a nitrogen source at 400° C. to 800° C. to form an N-doped carbon nanofoam;
iii. optionally, pitting the formed N-doped carbon nanofoam.

The nitrogen source may be added in step i. The subsequent heating results in a continuous distribution of nitrogen throughout the formed N-doped carbon nanofoam.

Accordingly, there is provided a method of forming an N-doped carbon nanofoam comprising the steps of:
i. providing a mixture of sugar, water, hydrocarbon mediator, and a nitrogen source;
ii. heating said mixture at 400° C. to 800° C. to form an N-doped carbon nanofoam;
iii. optionally, pitting the N-doped carbon nanofoam.

Step ii requires heating the mixture to form a nanofoam. The mixture is heated at a temperature and for a time sufficient to carbonise the sugar to form a particulate material.

In order to form an N-doped carbon nanofoam, the mixture of step i is heated in the presence of nitrogen.

Suitably, the mixture is heated in the presence of a nitrogen source at a temperature of from 400° C. to 800° C. for 5 minutes to 4 hours. Heating to a higher temperature usually requires a shorter heating time. For instance, the mixture may be heated to 800° C. for 5 minutes. Alternatively, the mixture may be heated to 400° C. for 4 hours. Heating the mixture for longer is of course possible, but this is usually not required.

Preferably, the mixture is heated in the presence of a nitrogen source at a temperature of from 600° C. to 800° C. for 5 minutes to 2 hours, for instance from 10 mins to 90 mins. Alternatively, the mixture is heated at a temperature of from 400° C. to 600° C. for 2 hours to 4 hours.

More preferably, the mixture is heated at 500 to 650° C. for 30 mins to 4 hours, for instance from 1 to 3 hours.

Without wishing to be bound by theory, higher temperatures may result in larger pore diameters and a more conductive material, while lower temperatures may result in smaller pore diameters. Given that smaller pore diameters are desired, lower temperatures are advantageous. However, lower temperatures (for instance below 400° C.) results in larger amounts of unreacted starting material, which may act as a contaminant in the nanofoam.

Therefore, a small, but not too small, temperature is desired. For example, a temperature of around 400° C. to 800° C.

The heating step carbonises the material to form a nanofoam. As such, the heating is typically carried out in a suitably inert vessel, for instance a Teflon coated hydrothermal reactor.

The heating step is preferably carried out in a sealed reactor under inert atmosphere.

### Alternative Method of Forming an N-Doped Carbon Nanofoam

Optionally, the mixture of step i is at least partly carbonised prior to heating the mixture in the presence of nitrogen. The heating of the mixture of step i results in at least partial formation of a carbon nanofoam. By partial formation of a carbon nanofoam is meant the formation of a carbon nanofoam in which unreacted sugars remain.

An example of a method of forming an N-doped carbon nanofoam in which the mixture of sugar, water, and hydrocarbon mediator is heated prior to addition of a nitrogen source comprises the steps of:
i. providing a mixture of sugar, water, and hydrocarbon mediator;
iia. heating said mixture at 100° C. to 600° C. to form a carbon nanofoam at least partially;
iib. heating said at least partially formed carbon nanofoam in the presence of a nitrogen source at 400° C. to 800° C. to form an N-doped carbon nanofoam;
iii. optionally, pitting the formed N-doped carbon nanofoam.

By heating the mixture of sugar, water, and hydrogen mediator prior to addition of a nitrogen source, a carbon nanofoam is at least partly formed prior to the addition of a nitrogen source. Therefore, the subsequent heating in the presence of a nitrogen source will result in inclusion of nitrogen predominantly on the surface of the carbon nanofoam.

In step iia, the mixture is suitably heated at a temperature of from 100° C. to 600° C. for 30 minutes to 24 hours. Heating to a higher temperature usually requires a shorter heating time. For instance, the mixture may be heated to 500° C. for 1 hour, or alternatively to 155° C. for 5 hours.

Preferably, step iia results in partial carbon nanofoam formation. This will leave unreacted sugars that will be carbonised along with the nitrogen source in step iia. By having some unreacted sugars together with the nitrogen source in the second heating step, the incorporation of nitrogen will work more efficiently.

To ensure only partial carbon nanofoam formation in step iia, typically, high temperatures and short reaction times will be applied. For example, 600° C. for 30 minutes.

Alternatively, when the reaction times are longer, step iia results in complete carbon nanofoam formation. The subsequent introduction of nitrogen may then lead to a decrease in the surface area of the resulting carbon nanofoam.

Step iib involves heating in the presence of a nitrogen source.

Suitably, the mixture is heated in the presence of a nitrogen source at a temperature of from 400° C. to 800° C. for 5 minutes to 4 hours. Heating to a higher temperature usually requires a shorter heating time. For instance, the mixture may be heated to 800° C. for 5 minutes. Alternatively, the mixture may be heated to 400° C. for 4 hours. Heating the mixture for longer is of course possible, but this is usually not required.

Preferably, the mixture is heated in the presence of a nitrogen source at a temperature of from 600° C. to 800° C. for 5 minutes to 2 hours, for instance from 10 mins to 90 mins. Alternatively, the mixture is heated at a temperature of from 400° C. to 600° C. for 2 hours to 4 hours.

More preferably, the mixture is heated at 500 to 650° C. for 30 mins to 4 hours, for instance from 1 to 3 hours.

Without wishing to be bound by theory, higher temperatures may result in larger pore diameters and a more conductive material, while lower temperatures may result in smaller pore diameters. Given that smaller pore diameters are desired, lower temperatures are advantageous. However, lower temperatures (for instance below 400° C.) results in larger amounts of unreacted starting material, which may act as a contaminant in the nanofoam. Therefore, a small, but not too small, temperature is desired. For example, a temperature of around 400° C. to 800° C.

The heating steps carbonises the material to form a nanofoam. As such, the heating is typically carried out in a suitably inert vessel, for instance a Teflon coated hydrothermal reactor.

The heating steps is preferably carried out in a sealed reactor under inert atmosphere.

### N-Doped Carbon Nanofoam

The N-doped carbon nanofoam resulting from the method of the present disclosure may be characterised as a superstructure of coalesced N-doped carbon nanofoam particles, said particles having a diameter of from 0.005 μm to 25 μm.

Preferably, the nanofoam particles are from 0.01 to 15 μm, preferably from 0.01 to 5 μm, more preferably from 0.01 to 2 μm in diameter.

The diameters of the nanofoam particles may be measured by SEM. Typically, in such a process the largest dimension of the particle is measured.

The average diameter may be calculated by taking the mean value of the measurement of the largest dimension of ten separate nanofoam particles.

The carbon nanofoam particles are typically mesoporous, i.e., having pores of 2 nm to 50 nm. The nanofoam particles are bound together by covalent interactions, resulting in a superstructure that is surprisingly retained even under mechanical stresses such as during milling.

The N-doped carbon nanofoam material of the disclosure is a continuous, or semi-continuous, interconnected superstructure of coalesced N-doped carbon nanofoam particles.

In an example, the N-doped carbon nanofoam material has a superstructure of coalesced N-doped carbon nanofoam particles, said superstructure having a tortuous path of open pores at least 3 times the average diameter of the nanofoam particles, preferably at least 5 times the average diameter of the nanofoam particles, for instance from 5 to 100 times, preferably from 5 to 50 times the average diameter of the nanofoam particles.

The open pores typically have an irregular shape. The pore size can be determined by SEM, with the average size of any given pore being defined as the mean of the largest and smallest dimension of that pore as determined by SEM.

The average size of the pores of the super structure will vary depending on the size of the particles of the nanofoam particles and are typically from 10 to 100 nm.

Typically, the surface pore sizes in an N-doped carbon nanofoam are around 2 to 10% larger that a carbon nanofoam without N-doped prepared by the same method (omitting nitrogen source for the undoped carbon nanofoam).

For example, the average size of the pores of the super structure of an N-doped carbon nanofoam may be from 10 to 120 nm.

The pore size of the mesopores may be determined by tunnelling electron microscopy. In such a process, the material may be coated with a metal such as titanium by sputtering. After coating, the pore structure can be observed using a tunnelling electron microscope, with the pore size being determinable from the image produced. Although the methodology provides an image of the surface, it is evident from the bulk reactivity of the material that the pores extend beneath the surface into the structure of the carbon. The material is therefore best described as a mesoporous N-doped carbon nanofoam.

The mean pore size can be determined by the mean of 10 average pore sizes, as determined by SEM.

Typically, the N content of the N-doped carbon nanofoam is from 0.1 to 15 wt %, for example from 0.5 to 12 wt %, such as from 2 to 12 wt %, for example from 6 to 12 wt %, such as from 8 to 11 wt %. Preferably the N content of the resultant material is 2 wt % or more, such as 6 wt % or more.

In an example, the surface area of the resultant material is typically from 200 to 3500 m²/g, preferably 400-3000 m²/g, preferably 1000 to 2500 m²/g, preferably 1000-2000 m²/g. For example, 1000-1800 m²/g, preferably 1200-1800 m²/g, preferably 1200-1600 m²/g.

The surface area may be measured by BET isotherm, for instance at 77 K using nitrogen.

In an example, the N-doped carbon nanofoam material has a density of below 300 mg/cm³, typically from 50 to 200 mg/cm³ and preferably from 50 to 150 mg/cm³.

The density of the N-doped carbon nanofoam material may be measured by weighing the bulk material and then correlating for the mass of the average element density.

The nanofoam particles may vary in shape, and the shape may be dependent on the sugar and hydrocarbon mediator that are used. For instance, glucose forms cube-like structures. Sucrose and naphthalene are preferred and give rise to approximately spherical particles.

The nanofoam particles are typically from 0.01 to 15 μm, preferably from 0.01 to 5 μm, more preferably from 0.01 to 2 μm in diameter.

### Protocols for Measurements

### Calculation of Pore Size

To calculate pore diameters of micropore levels and smaller, the inventors have used the protocol set out in Kawazoe et al., J. Chem. Eng. Japan, 16 (6), 1983, 470-475.

The above protocol describes a method for the calculation of effective pore size distribution from adsorption isotherms. Calculation of the pore size distribution was done from N₂ isotherms at 77 K.

For measurement of the N₂ isotherms at liquid N₂ temperature a sample (~0.3 g) was put into a sample holder and degassed at 200° C. and 10-5 Torr (1.33×10−3 Pa) pressure for at least 48 hours. A Cahn electrobalance provided highly accurate mass measurement. For the measurement of pressure ULVAC ionization vacuum gauges and MKS Baratron sensors were used (pressure ranges 1.33×10⁻⁶-6.65×10⁻¹ Pa; 1.33×10⁻¹-10⁵ Pa).

To calculate pore volumes greater than 1.5 nm, the inventors have used the following protocol: Dollimore, D. and G. R. Heal et al., J. Appl. Chem., 14, 1964, 109-114.

The above protocol describes a method for calculating the pore size distribution from adsorption isotherms on porous solids.

Herein, the total amount of nitrogen taken up at a pressure of 1 atmosphere and a temperature of 77K gave the total pore volume. With the model of cylindrical pores the total pore volume was calculated using:

$$1 / 4 * pi * d * d * l ,$$

where
d is the mean pore diameter and
l is the total length of the pores.

If the BET surface area measured the total surface area of the pores, the BET surface area S(BET)=pi*d*l. From the two equations l was eliminated and the average diameter d was calculated.

The Barrett-Joiner-Halenda (BJH) procedure assumes capillary condensation of the liquid nitrogen within the pores and calculates from the relative pressures and the amount of nitrogen taken up at a given relative pressure of the sorption isotherm taking into account the adsorbed layer of nitrogen and the capillary condensed nitrogen the pore size distribution. The adsorption and the desorption branch lead to different pore size distributions. Therefore, the desorption branch was usually employed.

### Surface Area

Samples were treated at elevated temperatures (120° C.) and reduced pressures for at least 8 hours before nitrogen sorption to remove any bound gases and adsorbed water from the materials.

The N₂ sorption analysis may be performed using a Belsorp Mini (Bel Japan, Inc.) apparatus at 77K, using liquid gas for each respective test, and surface areas calculated using the Brunauer-Emmett-Teller (BET) theory using sorption data.

### Calculation of Density for Carbon Nanofoams

The following methods were used:

Displacement density method: using water as the displacement medium, density is calculated at 22° C., 1 atm of pressure and using the equation D=m/v (mass divided by volume).

TAP density method, as described by:
The International Pharmacopoeia, s.3.6. Bulk Density and Tapped Density of Powders, QAS11_450 FINAL (modified March 2012). The tapped density is an increased bulk density attained after mechanically tapping a container containing the powder sample.
Here, the tapped density is obtained by mechanically tapping a graduated cylinder containing the sample until little further volume change is observed. The tapping can be performed using different methods. The tapped density is calculated as mass divided by the final volume of the powder.

A mean average was subsequently taken of the two measurement methodologies.

1. A method of forming an N-doped carbon nanofoam comprising the steps of
i. providing a mixture of sugar, water, and hydrocarbon mediator;
ii. heating said mixture in the presence of a nitrogen source at 400° C. to 800° C. to form an N-doped carbon nanofoam;
iii. optionally, pitting the formed N-doped carbon nanofoam.

2. The method of claim 1, wherein the nitrogen source is added in step i.

3. The method of claim 1, comprising the steps of:
i. providing a mixture of sugar, water, hydrocarbon mediator and a nitrogen source;
ii. heating said mixture at 400° C. to 800° C. to form an N-doped carbon nanofoam;
iii. optionally, pitting the N-doped carbon nanofoam.

4. The method of claim 1, wherein the mixture of sugar, water, and hydrocarbon mediator is heated prior to addition of a nitrogen source.

5. The method of claim 4 comprising the steps of:
i. providing a mixture of sugar, water, and hydrocarbon mediator;
iia. heating said mixture at 100° C. to 600° C. to form a carbon nanofoam at least partially;
iib. heating said at least partially formed carbon nanofoam in the presence of a nitrogen source at 400° C. to 800° C. to form an N-doped carbon nanofoam;
iii. optionally, pitting the N-doped carbon nanofoam.

6. The method of claim 1, wherein the nitrogen source is selected from the group consisting of ammonia; urea; melamine; proteins such as albumin or egg whites; polymers such as polyacrylonitrile, polyvinylpyridine; heteroaromatic compounds such as triazine, pyrimidine, pyridazine, pyrazine, pyridine, pyrrole, imidazole, pyrazole, and 1,2,4-triazole; coal tar pitch; and/or mixtures thereof.

7. The method of claim 1, wherein the nitrogen source is decomposed thermally.

8. The method of claim 1, wherein, the nitrogen source is decomposed mechanically.

9. The method of claim 1, wherein the N content of the N-doped carbon nanofoam is from 0.1 to 15 wt %.

10. The method of claim 1, wherein the mixture of sugar and water is at least 3 molar.

11. The method of claim 1, wherein the weight ratio of hydrocarbon mediator to sugar is from 1:25,000 to 1:75,000.

12. The method of claim 1, wherein the hydrocarbon mediator is selected from the group consisting of pyrene, chrysene, benz[a]anthracene, fluoranthene, anthracene, naphthalene, benzene, hexane and/or mixtures thereof, with anthracene, naphthalene or benzene being preferred and naphthalene being most preferred.

13. The method of claim 1, wherein suitable sugars include monosaccharides, disaccharides and trisaccharides.

14. The method of claim 1, wherein suitable sugars include sucrose, glucose or fructose, with sucrose being preferred.

15. The method of claim 1, wherein the N-doped carbon nanofoam undergoes pitting.

16. An N-doped carbon nanofoam according to claim 1.
